(19) United States
(12) Patent Application Publication
(10) Pub. No.: US 2010/0089738 A1
(43) Pub. Date: Apr. 15, 2010

(54) HYDROMECHANICAL STORED-ENERGY SPRING MECHANISM

(75) Inventors: Joachim Eggers, Hanau (DE); Claus Sticker, Grosskrotzenburg (DE)

Correspondence Address: BUCHANAN, INGERSOLL & ROONEY PC, POST OFFICE BOX 1404, ALEXANDRIA, VA, 22313-1404, US

(73) Assignee: ABB TECHNOLOGY AG, Zurich (CH)

(21) Appl. No.: 12/575,218

(22) Filed: Oct. 7, 2009

(30) Foreign Application Priority Data
Oct. 7, 2008 (DE) 10 2008 050 674.5

(51) Int. Cl. H01H 33/28

(52) U.S. Cl. 200/82 B

(57) ABSTRACT

A hydromechanical stored-energy spring mechanism is provided for acting upon high-voltage switches. The mechanism includes a drive cylinder having a piston guided therein. The mechanism also includes a piston rod which is articulated on the piston and which penetrates centrally through a cylinder block provided with a reception bore as a guide for a damping ring. The damping ring is arranged in the reception bore of the cylinder block. The outside of the damping ring bears on the cylinder block housing, and the outside of the damping ring has a protuberance.

### RELATED APPLICATION

This application claims priority under 35 U.S.C. §119 to German Patent Application No. 10 2008 050 674.5 filed in Germany on Oct. 7, 2008, the entire content of which is hereby incorporated by reference in its entirety.

### FIELD

The present disclosure relates to a hydromechanical stored-energy spring mechanism for acting upon high-voltage switches.

### BACKGROUND INFORMATION

Hydromechanical stored-energy spring mechanisms are used in electrical switching installations, such as for acting upon high-voltage switches. They can combine the advantages of known hydraulic drives and stored-energy spring mechanisms. On the one hand, such hydromechanical stored-energy spring mechanisms can include a spring assembly formed from cup springs and, on the other hand, can include a hydraulic drive with a hydraulic cylinder and a piston which is guided in the cylinder and on which a piston rod is articulated. In this case, the hydraulic drive, which cooperates with the spring assembly, serves to tension the springs of the spring assembly, so that the stored spring energy can be dimensioned to be sufficient to ensure as quick a separation as possible of the electrical contacts of the electrical switch.

In this case, an adapted damping of the linear movement can be used to provide a controlled movement sequence.

Damping can be achieved using a damping ring which is arranged on the cylinder block and surrounds the piston rod. The exact installation position of the damping ring should be taken into consideration.

It has been shown that, if the damping ring is not installed exactly, a tilting of the piston rod, and consequently a destructed movement sequence of the movable parts involved, may sometimes occur when high-voltage switches in electrical switching installations are switched on and off.

An inexact installation position of the cylindrical damping ring may be due to the fact that it is not inserted accurately into the reception bore on the cylinder block, but is, instead, tilted.

### SUMMARY

An exemplary embodiment provides a hydromechanical stored-energy spring mechanism for acting upon high-voltage switches. The exemplary mechanism comprises: a cylinder block having a reception bore; a drive cylinder configured to have a piston guided therein; a damping ring arranged in the reception bore of the cylinder block; and a piston rod which is articulated on said piston and which penetrates centrally through the cylinder block as a guide for the damping ring. The outside of the damping ring bears on the cylinder block housing, and the outside of the damping ring has a protuberance.

### BRIEF DESCRIPTION OF THE DRAWINGS

Additional features, refinements, improvements, and advantages of the present disclosure will be explained in more detail below with reference to exemplary embodiments illustrated in the accompanying drawings, in which:

FIG. 1 shows a known hydromechanical stored-energy spring mechanism with a damping ring;

FIG. 2 shows an exemplary hydromechanical stored-energy spring mechanism with a damping ring according to at least one embodiment of the present disclosure; and

FIG. 3 shows an enlarged perspective view of an exemplary configuration of a damping ring according to at least one embodiment of the present disclosure.

### DETAILED DESCRIPTION

Exemplary embodiments of the present disclosure provide a hydromechanical stored-energy spring mechanism which can operate in as fault-free a manner as possible.

According to an exemplary embodiment, the hydromechanical stored-energy spring mechanism includes a damping ring, which is arranged in the reception bore of a cylinder block. The outside of the damping ring bears on the cylinder block housing, and has a protuberance on its outside surface.

An advantageous aspect achieved by this exemplary configuration of the damping ring is that when the damping ring is mounted for installation, the damping ring can first be inserted easily into the cylindrical reception bore, without undesirable tilting occurring. Furthermore, it becomes possible to appropriately orient the central recess of the damping ring to receive the piston rod as a function of the respective position or orientation of the piston rod and therefore ensure an undisturbed movement sequence.

According to a exemplary embodiment of the disclosure, the outside of the damping ring can have a crowned form. For example, the outer contour of the damping ring can be configured so that it has, in each case, only an approximately linear surface of contact with the reception bore. This exemplary configuration can ensure that the damping ring does not tilt under any circumstance, and thereby prevent a malfunction of the stored-energy spring mechanism.

According to an exemplary embodiment of the present disclosure, the outside of the damping ring can be provided with a predetermined series of radii which can achieve a crowned outer contour.

Accordingly, the outside of the damping ring can be provided with a predetermined series of chamfers, to achieve desired crowning of the outer surface of the damping ring.

According to an exemplary embodiment of the present disclosure, the outer contour of the damping ring can be of a barrel-shaped design.

In general, in exemplary configurations of the damping ring in a hydromechanical stored-energy spring mechanism according to the present disclosure, the damping ring can function to damp the movement sequence of the involved movable parts of the hydromechanical stored-energy spring mechanism during a switching action of high-voltage switches of electrical switching installations.

When high-voltage switches of electrical switching installations are switched on or off, a damping ring can be provided for decelerating the movement of the piston rod arranged in a stored-energy spring mechanism, such as in the case of hydraulic drive cylinders of hydromechanical drives, for example.

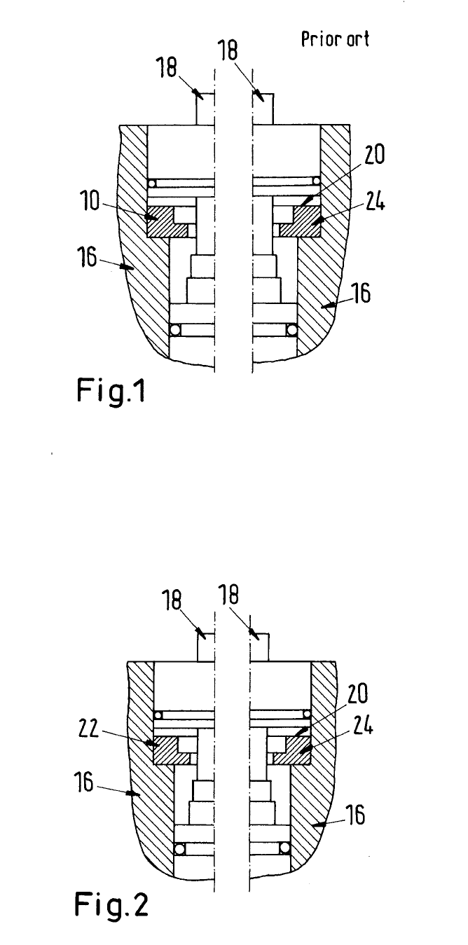

FIG. 1 shows a damping ring 10 which, according to the prior art, is arranged in the middle of a drive cylinder 12 of a hydromechanical stored-energy spring mechanism 14 between a cylinder block housing 16 and a piston rod 18 in a reception bore 20 of the cylinder block 16. The damping ring 10 is of a circular-cylindrical design. The outer surface of the damping ring 10 therefore corresponds to the surface area of a cylinder, and the outside of the damping ring 10 bears on the cylinder block housing 16.

During a switching action of the high-voltage switch, the piston rod 18 of the hydromechanical stored-energy spring mechanism 14 is moved. The damping ring 10 is provided for decelerating or damping of the movement of the piston rod 18. The circular-cylindrical configuration of the damping ring 10 may lead to a situation where the damping ring 10 is, for example, tilted and/or jammed in the reception bore 20 of the cylinder block 16, and this may restrict the damping of the piston rod 18 and possibly even lead to damping failure during the switching action.

Owing to the circular-cylindrical configuration of the damping ring 10, a tilting and/or jamming of the damping ring 10 in the reception bore 20 of the cylinder block 16 may occur even when the hydromechanical stored-energy spring mechanism 14 is being assembled.

FIG. 2 shows an exemplary hydromechanical stored-energy spring mechanism 21 according to at least one embodiment of the present disclosure. The exemplary hydromechanical stored-energy spring mechanism 21 includes a piston rod 18 of the hydraulic drive cylinder 12. A damping ring 22 is arranged in the middle of the drive cylinder 12 in the reception bore 20 between the cylinder block housing 16 and the switch rod designed as a piston rod 18. The hydraulic drive cylinder 12 of the stored-energy spring mechanism 14 operates based on the differential piston principle.

According to an exemplary embodiment, the damping ring 22 serves to facilitate the deceleration of switching actions of the hydromechanical stored-energy spring mechanism 14 with the hydraulic drive cylinder 12 and with the piston rod 18 arranged in the drive cylinder 12. In contrast to the damping ring 10 illustrated in FIG. 1, the outer surface of the damping ring 22 does not have a circular-cylindrical configuration in the same way as the damping ring 10 illustrated in FIG. 1. On the other hand, the outer surface of the damping ring 22 is provided with a crowned protuberance 24. For example, the damping ring 22 can be designed as a concavely rounded surface instead of as the surface area of a cylinder.

An exemplary embodiment provides that the damping ring 22 has a crowned protuberance 24 formed on its outside, which can provide, as compared with a cylindrical version, a better damping behavior of the hydromechanical stored-energy spring mechanism 14 during a switching action, and can be mounted in a simpler way.

The damping ring 22 bears with its curved outside 24 (e.g., approximately linearly) on the cylinder block housing 16. The outside 24 of the damping ring 22 can be designed as a crowned contour, with the result that a tilting and/or jamming of the damping ring 22 in the reception bore 20 of the cylinder block 16 during the movement of the switch rod 18 can be avoided, and the damping of the moved switch rod 22 is ensured.

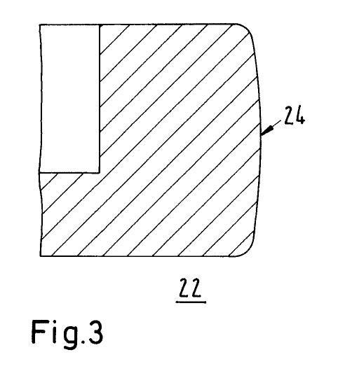

FIG. 3 shows an enlarged perspective view of the damping ring 22 according to according to at least one exemplary embodiment having the curved outer contour 24. The curved outer contour 24 of the damping ring 22 is achieved by means of corresponding series of radii or of chamfers or machining contours with tangential transitions during the production of the damping ring 22.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

10 Damping ring
12 Drive cylinder
14 Hydromechanical stored-energy spring mechanism
16 Cylinder block housing
18 Piston rod/switch rod
20 Reception bore
21 Hydromechanical stored-energy spring mechanism
22 Damping ring
24 Crowned protuberance

What is claimed is:

1. A hydromechanical stored-energy spring mechanism for acting upon high-voltage switches, comprising:
a cylinder block having a reception bore;
a drive cylinder configured to have a piston guided therein;
a damping ring arranged in the reception bore of the cylinder block; and
a piston rod which is articulated on said piston and which penetrates centrally through the cylinder block as a guide for the damping ring,
wherein the outside of the damping ring bears on the cylinder block housing, and the outside of the damping ring has a protuberance.

2. The hydromechanical stored-energy spring mechanism according to claim 1, wherein the outside of the damping ring is of a crowned form.

3. The hydromechanical stored-energy spring mechanism according to claim 1, wherein the outside of the damping ring comprises a predetermined series of radii providing a crowned outer contour.

4. The hydromechanical stored-energy spring mechanism according to claim 1, wherein the outside of the damping ring comprises a predetermined series of chamfers.

5. The hydromechanical stored-energy spring mechanism according to claim 1, wherein the outer contour of the damping ring is of a barrel-shaped design.

6. The hydromechanical stored-energy spring mechanism according to claim 1, wherein the damping ring is configured to damp a movement sequence of a hydromechanical stored-energy spring mechanism during a switching action.

7. The hydromechanical stored-energy spring mechanism according to claim 2, wherein the outside of the damping ring comprises a predetermined series of radii providing a crowned outer contour.

8. The hydromechanical stored-energy spring mechanism according to claim 2, wherein the outside of the damping ring comprises a predetermined series of chamfers.

9. The hydromechanical stored-energy spring mechanism according to claim 3, wherein the outside of the damping ring comprises a predetermined series of chamfers.

10. The hydromechanical stored-energy spring mechanism according to claim 4, wherein the outer contour of the damping ring is of a barrel-shaped design.

11. The hydromechanical stored-energy spring mechanism according to claim 10, wherein the damping ring is configured to damp a movement sequence of a hydromechanical stored-energy spring mechanism during a switching action.
